(19) United States
(12) Patent Application Publication
(10) Pub. No.: US 2020/0083719 A1
(43) Pub. Date: Mar. 12, 2020

(54) POWER TRANSMISSION DEVICE AND POWER RECEPTION DEVICE

(71) Applicant: KABUSHIKI KAISHA TOSHIBA, Tokyo (JP)

(72) Inventors: Masatoshi SUZUKI, Susono (JP); Yasuhiro KANEKIYO, Yokohama (JP)

(73) Assignee: KABUSHIKI KAISHA TOSHIBA, Tokyo (JP)

(21) Appl. No.: 16/292,550

(22) Filed: Mar. 5, 2019

(30) Foreign Application Priority Data
Sep. 10, 2018 (JP) 2018-168939

(51) Int. Cl. H02J 5/00; H02J 50/40; H02J 7/02; H02J 50/12; H02J 50/80; H02M 7/5387

(52) U.S. Cl. CPC H02J 5/005; H02J 50/40; H02M 7/53871; H02J 50/12; H02J 50/80; H02J 7/025

(57) ABSTRACT

According to one embodiment, a power transmission device includes an inverter including a first arm having first and second switching devices, and a second arm having third and fourth switching devices. The first control circuit controls first to fourth switching signals to generate AC power. The power transmission resonator couples a magnetic field corresponding to the AC power to a coil of a power reception unit to transmit the AC power, the power transmission resonator includes a first end connected to a connection point between the first and second switching devices, and a second end connected to a connection point between the third and fourth switching devices. The first control circuit sweeps a frequency of the AC power during the transmission of the AC power. The first control circuit controls to suppress variation of a time delay amount between the first and second arms during sweeping of the frequency.

### CROSS REFERENCE TO RELATED APPLICATIONS

This application is based upon and claims the benefit of priority from the prior Japanese Patent Application No. 2018-168939, filed on Sep. 10, 2018, the entire contents of which are incorporated herein by reference.

### FIELD

Embodiments described herein relate to a power transmission device and a power reception device.

### BACKGROUND

In a wireless power transmission system, power is wirelessly transmitted from a power transmission device to a power reception device. The power transmission device radiates a magnetic field generated by a coil to a space, and the power reception device couples the magnetic field to a coil, thereby receiving the power. In such wireless power transmission, it is necessary to suppress intensity of the magnetic field (radiation magnetic field) radiated from the power transmission device, to not more than values conforming to laws and regulations represented by Radio Act.

There is a technology in which a frequency is modulated (swept) within a preset frequency range to disperse the intensity of the radiation magnetic field on a time axis in order to suppress the intensity of the radiation magnetic field. In the technology, however, there is an issue that ripple of a receiving voltage occurs on the power reception device side. Occurrence of the ripple causes increase of a load to an electric circuit and decrease of a battery lifetime.

There is a technology in which amplitude of an input voltage on power transmission side is controlled to follow the modulation of the frequency in order to reduce variation of the receiving voltage on power reception side. In the technology, however, it is necessary to separately provide a table of relationship data between the frequency and the amplitude of the input voltage, or to feed back a state of the receiving voltage, etc. on the power reception side to the power transmission side at high speed. This complicates the system configuration.

### BRIEF DESCRIPTION OF THE DRAWINGS

FIG. 1 is a diagram illustrating an overall configuration of a wireless power transmission system according to a first embodiment;

FIG. 2 is a diagram illustrating a specific example of a power transmission device;

FIGS. 3A to 3C each is a diagram illustrating a specific example of a power transmission resonator and a power reception resonator;

FIG. 4 is a diagram illustrating a configuration example of an inverter;

FIGS. 5A to 5C each is a diagram illustrating an example of relationship between switching signals and an output voltage of the inverter;

FIGS. 6A to 6C each is a diagram illustrating another example of the relationship between the switching signals and the output voltage of the inverter;

FIG. 7 is a diagram illustrating a specific example of a power reception device;

FIG. 8 is a diagram illustrating an example of frequency sweeping;

FIG. 9 is a diagram illustrating relationship between a frequency and a receiving current;

FIGS. 10A and 10B each is a diagram illustrating an example of a database;

FIG. 11 is a flowchart of operation by a control circuit according to the first embodiment;

FIG. 12 is a diagram illustrating an overall configuration of a wireless power transmission system according to a second embodiment;

FIG. 13 is a flowchart of operation by a control circuit according to the second embodiment;

FIG. 14 is a diagram illustrating an overall configuration of a wireless power transmission system according to a third embodiment;

FIG. 15 is a flowchart of operation by a control circuit on power reception side according to the third embodiment;

FIG. 16 is a diagram illustrating an overall configuration of a wireless power transmission system according to a fourth embodiment;

FIG. 17 is a flowchart of operation by a control circuit on power reception side according to the fourth embodiment; and

FIG. 18 is a diagram illustrating a wireless power transmission system according to a sixth embodiment.

### DETAILED DESCRIPTION

According to one embodiment, a power transmission device includes an inverter, a first control circuit and a power transmission resonator.

The inverter includes a first arm and a second arm that are connected in parallel, the first arm including series connection of first and second switching devices, and the second arm including series connection of third and fourth switching devices.

The first control circuit controls first to fourth switching signals to be supplied to the first to fourth switching devices, to generate AC power from the inverter.

The power transmission resonator couples a magnetic field corresponding to the AC power to a coil of a power reception unit to transmit the AC power. The power transmission resonator includes a first end and a second end, the first end being electrically connected to a connection point between the first and second switching devices, and the second end being electrically connected to a connection point between the third and fourth switching devices.

The first control circuit sweeps a frequency of the AC power during the transmission of the AC power.

The first control circuit controls to suppress variation of a time delay amount between the first and second arms during sweeping of the frequency.

### First Embodiment

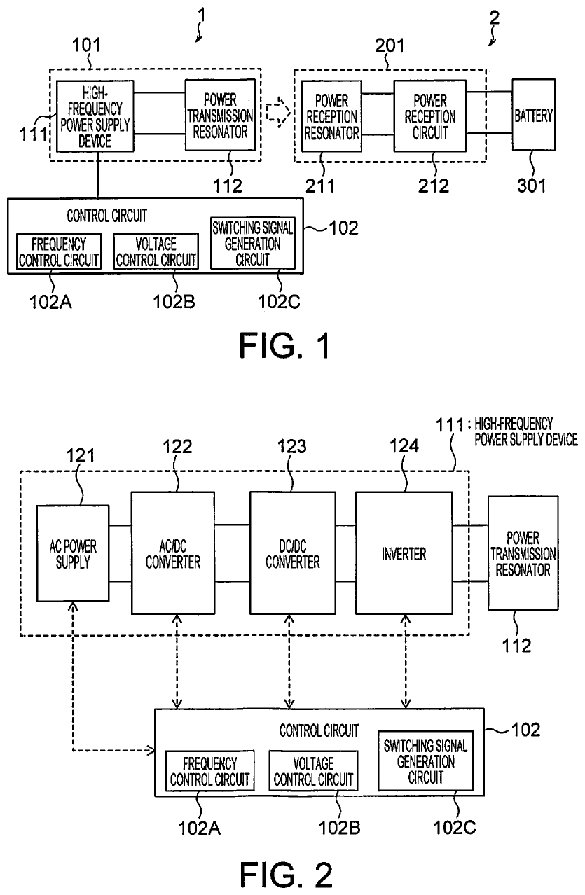

FIG. 1 illustrates an overall configuration of a wireless power transmission system according to a first embodiment. The system includes a power transmission device 1 that wirelessly transmits AC power, and a power reception device 2 that receives the AC power transmitted from the power transmission device 1. The power transmission device 1 generates the AC power from DC power, and causes a power transmission resonator 112 to generate a magnetic field corresponding to the generated AC power. The power reception device 2 causes a power reception resonator 211 to couple the magnetic field, thereby receiving the AC power from the power transmission device 1. The power reception device 2 converts the received AC power into DC power, and charges the DC power in a battery 301.

The power transmission device 1 includes a power transmission unit 101 and a control circuit 102. The power transmission unit 101 includes a high-frequency power supply device 111 that is an AC power supply device, and the power transmission resonator 112. The control circuit 102 includes a frequency control circuit 102A, a voltage control circuit 102B, and a switching signal generation circuit 102C.

The power reception device 2 includes a power reception unit 201 and the battery 301. The power reception unit 201 includes the power reception resonator 211 and a power reception circuit 212. In this example, the battery 301 is a part of the power reception device 2; however, the battery 301 may be defined separately from the power reception device 2. FIG. 2 illustrates a specific example of a configuration of the power transmission device 1 in FIG. 1.

In FIG. 2, the high-frequency power supply device 111 includes an AC power supply 121, an AC/DC converter 122, a DC/DC converter 123, and an inverter 124. The high-frequency power supply device 111 generates high-frequency power that is the AC power, and supplies the generated high-frequency power to the power transmission resonator 112. Components 121 to 124 of the high-frequency power supply device 111 are connected to the control circuit 102, and are controlled by the control circuit 102. Control signals or data signals that are transmitted and received between the components 121 to 124 and the control circuit 102 are illustrated by dashed lines. Examples of the control signals include a signal instructing operation of each of the components by the control circuit 102. Examples of the data signals include a signal that notifies, to the control circuit 102, an operation state of each of the components and a value of one or both of a voltage and a current at a predetermined position. The control signal and the data signal may be a signal other than the signals described here.

The AC power supply 121 supplies AC power (AC voltage and AC current) of a fixed frequency. Examples of the AC power supply 121 include a commercial power supply. The commercial power supply outputs, for example, the AC voltage of single-phase 100 V or three-phase 200V at frequency of 50 Hz or 60 Hz.

The AC/DC converter 122 is a circuit that is connected to the AC power supply 121 through a wiring (e.g., cable) and converts the voltage of the AC power supplied from the AC power supply 121 into a DC voltage.

The DC/DC converter 123 is a circuit that is connected to the AC/DC converter 122 through a wiring and converts (steps up or steps down) the DC voltage supplied from the AC/DC converter 122 into a different DC voltage. The DC/DC converter 123 includes switching devices such as semiconductor switches, and controls the switching devices to perform voltage conversion. A step-up ratio or a step-down ratio (hereinafter, referred to as step-up/down ratio) can be controlled by controlling an operation frequency of each of the switching devices or a pulse width of switching. The DC/DC converter 123 may be omitted.

The inverter 124 is a circuit (DC/AC converter) that is connected to the DC/DC converter 123 through a wiring, and generates AC power (AC current and AC voltage) based on the DC voltage supplied from the DC/DC converter 123. In this example, the inverter 124 generates high-frequency power as the AC power. The inverter 124 supplies the generated AC power to the power transmission resonator 112.

The power transmission resonator 112 is connected to the inverter 124 through a wiring. The power transmission resonator 112 is a resonance circuit that includes a coil (inductor) and a capacitor (capacitance). The power transmission resonator 112 generates, by the coil, a magnetic field corresponding to the high-frequency power (high-frequency current) received from the inverter 124, and couples the magnetic field to a coil of the power reception resonator 211 of the power reception device 2, thereby performing wireless power transmission.

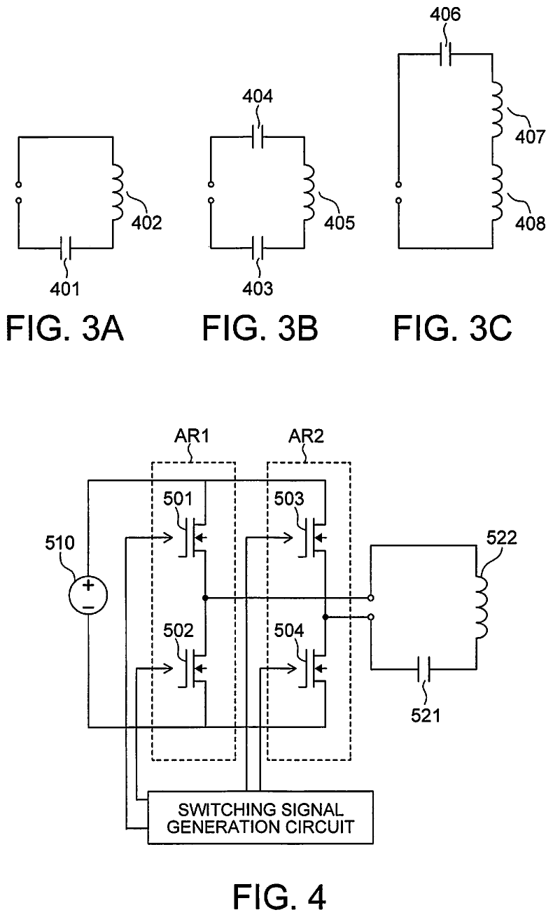

FIG. 3A, FIG. 3B, and FIG. 3C each illustrate a configuration example of the power transmission resonator 112. In the configuration of FIG. 3A, a capacitor 401 is connected in series to one end of a coil 402. The capacitor 401 may be connected to side opposite to the side of FIG. 3A, namely, to the other end of the coil 402. Capacitors 403 and 404 may be connected to respective sides of a coil 405 as illustrated in FIG. 3B, or a plurality of coils 407 and 408 and a capacitor 406 may be connected in series as illustrated in FIG. 3C. Each of the coils 402, 405, 407, and 408 illustrated in FIG. 3A to FIG. 3C may be wound around a magnetic core. A coil may be optionally wound, for example, spirally wound and solenoid wound. A configuration other than the configurations illustrated in FIG. 3A to FIG. 3C is also available. The power reception resonator 211 is also achievable by any of the configurations of FIG. 3A to FIG. 3C, or other configurations.

The configuration of the high-frequency power supply device 111 is not limited to the configuration of FIG. 2. For example, a circuit such as a filter circuit may be inserted between the DC/DC converter 123 and the inverter 124.

FIG. 4 illustrates a configuration example of the inverter 124. The inverter 124 is a full-bridge inverter including switching devices 501, 502, 503, and 504. Specific examples of each of the switching devices 501 to 504 include a semiconductor device such as an FET (Field-Effect Transistor) and an IGBT (Insulated Gate Bipolar Transistor). FIG. 4 illustrates a case of the FET device. One end of the switching device 501 and one end of the switching device 502 are connected to each other, and one end of the switching device 503 and one end of the switching device 504 are connected to each other. The other ends of the respective switching devices 501 and 503 are connected to a power supply terminal of a DC power supply 510 in common, and a power supply voltage is accordingly supplied from the DC power supply 510. The other ends of the respective switching devices 502 and 504 are connected to a ground terminal of the DC power supply 510 in common, and a ground voltage is accordingly supplied from the DC power supply 510. The DC power supply 510 corresponds to the DC/DC converter 123 in FIG. 2. The voltage of the DC power supply 510 corresponds to the output voltage of the DC/DC converter 123. A pair of the switching devices 501 and 502 corresponds to a first arm AR1, and a pair of the switching devices 503 and 504 corresponds to a second arm AR2. The first arm AR1 and the second arm AR2 are connected in parallel. A connection node between the switching devices 501 and 502 is connected to one of terminals of the power transmission resonator 112, and a connection node between the switching devices 503 and 504 is connected to the other terminal of the power transmission resonator 112. As an example, the one terminal corresponds to a positive output terminal, and the other terminal corresponds to a negative output terminal. A potential difference between the terminals corresponds to the output voltage of the inverter 124. The power transmission resonator 112 includes a capacitor 521 and an inductor 522. The power transmission resonator 112 includes a configuration similar to the configuration of FIG. 3A; however, the power transmission resonator 112 may include a configuration similar to the configuration of FIG. 3B or FIG. 3C.

The inverter 124 drives the switching devices in response to respective switching signals provided from the switching signal generation circuit 102C, based on the power supply voltage and the ground voltage that are supplied from the DC power supply 510, thereby generating the AC power (AC voltage or AC current). The switching signals each have a pulse waveform. In the following, the switching signals to be supplied to the respective switching devices 501 to 504 are denoted by switching signals 501 to 504 with use of the reference numerals same as the switching devices.

The switching signal generation circuit 102C is configured of a PLL (Phase Locked Loop) that generates a reference signal (clock), a plurality of variable phase shifters, etc. As a simple configuration example, the reference signal output from the PLL is input to the variable phase shifters corresponding to the respective switching devices. A parameter to shift a phase of the input reference signal by a predetermined shift amount is set to each of the variable phase shifters. An output signal of each of the variable phase shifters is input, as the switching signal, to a gate terminal of the corresponding switching device. The configuration described here is illustrative, and other various configurations such as a configuration using a delay device can be used.

The control circuit 102 controls the switching signal generation circuit 102C so as to complementarily drive the switching devices 501 and 502 and to complementarily drive the switching devices 503 and 504, thereby generating the switching signals 501 to 504. More specifically, the voltage control circuit 102B of the control circuit 102 can adjust phase relationship (time delay amount) of the switching signals 501 and 503, and adjust phase relationship (time delay amount) of the switching signals 502 and 504, thereby adjusting an effective value of the output voltage to the power transmission resonator. Further, the frequency control circuit 102A of the control circuit 102 can adjust a period (number of pulse repetition times per unit time) of each of the switching signals 501 to 504, thereby adjusting the frequency of the output current.

When the switching device 501 and the switching device 504 are ON and the switching device 502 and the switching device 503 are OFF, the current flows from the DC power supply 510 to the ground side of the DC power supply 510 through the switching device 501, the coil 522, and the switching device 504. When the switching device 501 and the switching device 504 are OFF and the switching device 502 and the switching device 503 are ON, the current flows from the DC power supply 510 to the ground side of the DC power supply 510 through the switching device 503, the coil 522, and the switching device 502. The current changed in direction is generated by controlling the ON-OFF switching of each of the switching devices in the above-described manner, which generates the AC power. The AC current is supplied to the power transmission resonator to generate an electromagnetic field. When the electromagnetic field is coupled to the coil of the power reception resonator on the power reception side, the power is transmitted.

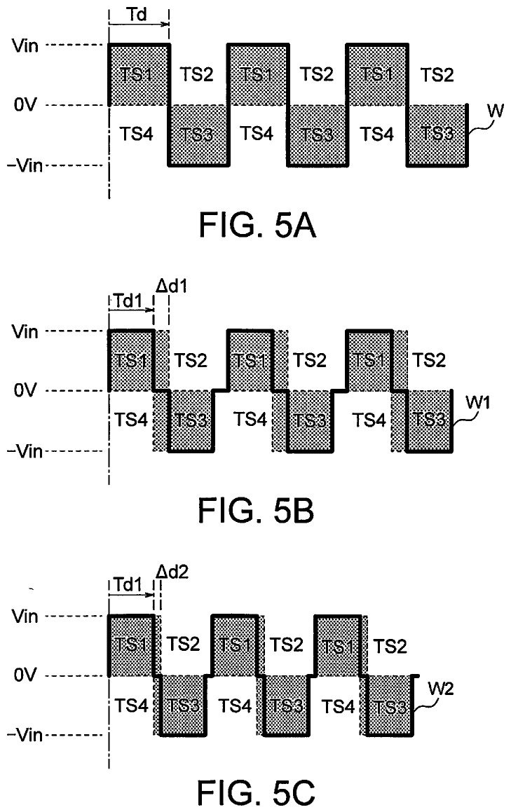

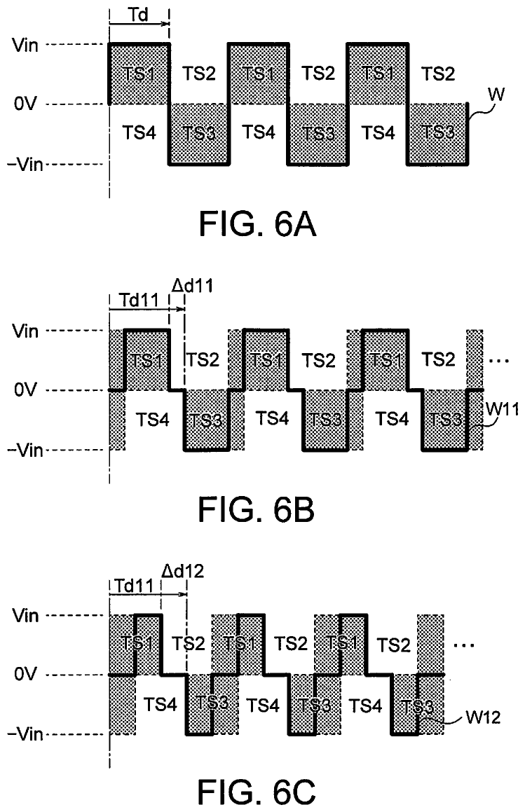

The relationship between the switching signals 501 to 504 and the output voltage of the inverter 124 is described with reference to FIG. 5 and FIG. 6.

FIG. 5A is a diagram illustrating an example of the relationship between the switching signals 501 to 504 and the output voltage of the inverter 124 at a certain power transmission frequency fa [Hz]. On upper side in FIG. 5A, a time section TS1 in which the switching signal 501 is at a high level (switching signal 502 is at low level) and a time section TS2 in which the switching signal 501 is at the low level (switching signal 502 is at high level) are alternately repeated along the time axis. The time sections TS1 and TS2 have the same length. In other words, a time rate of the high level and a time rate of the low level of the switching signal 501 are equal to each other (i.e., duty ratio=½). Likewise, a duty ratio of the switching signal 502 is also ½.

On lower side in FIG. 5A, a time section TS3 in which the switching signal 503 is at the high level (switching signal 504 is at low level) and a time section TS4 in which the switching signal 503 is at the low level (switching signal 504 is at high level) are alternately repeated. The time sections TS3 and TS4 have the same length. A duty ratio of the switching signal 503 is ½. Likewise, a duty ratio of the switching signal 504 is also ½.

A waveform W represents the output voltage of the inverter 124. A period Ta of the power transmission frequency is 1/fa [second]. The period of each of the switching signals 501 to 504 is Ta (=1/fa) that is the same as the period of the power transmission frequency. A pulse width of each of the switching signals 501 to 504 is ½ of the period Ta (i.e., 1/(2fa)). The switching signal 503 (or switching signal 504) is delayed by a time Td from the switching signal 501 (or switching signal 502). In other words, the second arm AR2 is delayed by the time Td from the first arm AR1. In other words, the time delay amount between the first arm AR1 and the second arm AR2 (hereinafter, interarm delay amount) is Td. A phase difference corresponding to the time Td is 180 degrees when one period is 360 degrees.

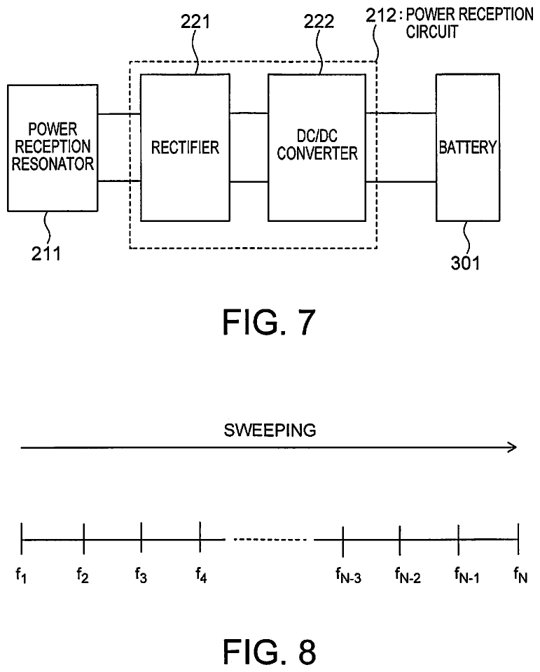

FIG. 5B illustrates an example in which the time delay amount between the first arm AR1 and the second arm AR2 is made smaller than the time delay amount in FIG. 5A, at the power transmission frequency same as the power transmission frequency of FIG. 5A. A time Td1 is shorter by Δd1 than the time Td. The phase difference corresponding to the time Td1 is a value reduced by the phase amount (phase shift amount) corresponding to the time Δd1 from 180 degrees. As compared with FIG. 5A, a period when the output voltage is zero is inserted in each period. As a result, the effective value of the output voltage is reduced. A waveform W1 represents the output voltage of the inverter 124. The example in which the interarm delay amount is made smaller than the interarm delay amount Td in FIG. 5A is illustrated here; however, the interarm delay amount may be made larger than the interarm delay amount in FIG. 5A (see FIG. 7 described later).

FIG. 5C illustrates an example in which the interarm delay amount is set to Td1 that is the same as the interarm delay amount in FIG. 5B while the power transmission frequency is changed to a frequency fb higher than the frequency fa. A period Tb of the power transmission frequency is 1/fb [second]. The switching signals 501 to 504 include the same period Tb. A repetition frequency of ON/OFF of the pulses is shorter than a repetition frequency in FIG. 5B. In other words, the pulse width is reduced. The interarm delay amount is Td1 that is same as the interarm delay amount in FIG. 5B even though the period is reduced. Therefore, the phase difference between the arms is larger than the phase difference in FIG. 5B. A waveform W2 is a waveform of the output voltage of the inverter 124. Since the period when the output voltage is zero is shorter than the period in FIG. 5B, the effective value of the output voltage is larger than the effective value of the output voltage in FIG. 5B.

In FIG. 5B and FIG. 5C, the interarm delay amount is made smaller than the interarm delay amount Td of FIG. 5A. An example in which the interarm delay amount is made larger than the interarm delay amount Td is described with reference to FIG. 6.

FIG. 6A is a diagram illustrating the relationship between the switching signals 501 to 504 and the output voltage of the inverter 124 at the power transmission frequency fa [Hz]. FIG. 6A is the same as FIG. 5A.

FIG. 6B illustrates an example in which the time delay amount between the first arm AR1 and the second arm AR2 is made larger than the interarm delay amount Td of FIG. 6A, at the power transmission frequency same as the power transmission frequency of FIG. 6A. A time Td11 is longer by Δd11 than the time Td. The phase difference corresponding to the time Td11 is a value increased from 180 degrees by the phase amount (phase shift amount) corresponding to the time Δd11. As compared with a waveform in FIG. 6A, a period when the output voltage is zero is inserted in each period. As a result, the effective value of the output voltage is reduced. A waveform W11 represents the output voltage of the inverter 124.

FIG. 6C illustrates an example in which the interarm delay amount is set to Td11 that is the same as the interarm delay amount in FIG. 6B while the power transmission frequency is changed to the frequency fb higher than the frequency fa. The period Tb of the power transmission frequency is 1/fb [second]. The switching signals 501 to 504 include the same period Tb. The repetition frequency of ON/OFF of the pulses is shorter than the repetition frequency in FIG. 6B. In other words, the pulse width is reduced. The interarm delay amount is Td11 that is the same as the interarm delay amount in FIG. 6B even though the period is reduced. Therefore, the phase difference between the arms is larger than the phase difference in FIG. 6B. A waveform W12 is a waveform of the output voltage of the inverter 124. Since the period when the output voltage is zero is longer than the period in FIG. 6B, the effective value of the output voltage is smaller than the effective value of the output voltage in FIG. 6B.

As can be seen from the description of FIG. 5B, FIG. 5C, FIG. 6B, and FIG. 6C, increasing or decreasing the power transmission frequency (frequency of each of switching signals) while keeping (fixing) the time delay amount between the arms makes it possible to increase or decrease the output voltage. At this time, how the output voltage is changed depends on the value of the time delay amount, the change range of the frequency, etc. For example, in a case where the power transmission frequency is increased, the output voltage is gradually increased as the frequency is increased within the certain frequency range, whereas the output voltage is gradually decreased as the frequency is increased within a different frequency range.

The interarm delay amount in FIG. 5 and FIG. 6 may have the length exceeding one period of the pulse. For example, in FIG. 5B, the time delay amount exceeding one period can be represented by Td1+n/fa, where n is an integer. Each of the switching signals is a periodic signal and has the same waveform even if the phase is shifted by 360 degrees. Accordingly, the waveform of the output voltage in the case of the time delay amount Td1+n/fa is equivalent to the waveform of the output voltage in the case of the time delay amount Td1. The power reception unit 201 of the power reception device 2 in FIG. 1 includes the power reception resonator 211 and the power reception circuit 212. The power reception resonator 211 is coupled to the magnetic field radiated from the power transmission resonator 112 of the power transmission unit 101, thereby wirelessly receiving the AC power (high-frequency power). The power reception resonator 211 is coupled to the power transmission resonator 112 with an optional coupling coefficient. The power reception resonator 211 supplies the received AC power to the power reception circuit 212. As described above, the power reception resonator 211 can be achieved by, for example, the configuration of any of FIG. 3A to FIG. 3C. The resonance frequency of the power reception resonator 211 is the same as or close to the resonance frequency of the power transmission resonator 112. As a result, effective wireless power transmission is performed.

The power reception circuit 212 is connected to the power reception resonator 211 through a wiring, and converts the AC power received by the power reception resonator 211, into a DC voltage suitable for the battery 301, and outputs the DC voltage.

FIG. 7 illustrates a specific example of the configuration of the power reception device 2. The power reception circuit 212 includes a rectifier 221 and a DC/DC converter 222.

The rectifier 221 is connected to the power reception resonator 211 through a wiring, and converts the receiving power (AC power) received from the power reception resonator 211, into a DC voltage. In other words, the rectifier 221 is a circuit that converts AC into DC. The rectifier 221 includes, for example, a diode bridge; however, the rectifier may include other configurations.

The DC/DC converter 222 is connected to the rectifier 221 through a wiring, and converts the DC voltage output from the rectifier 221 into a voltage (higher than, equal to, or lower than DC voltage) usable by the battery 301, and outputs the voltage. The DC/DC converter 222 includes switching devices such as semiconductor switches, and controls these switching devices to perform voltage conversion. For example, a step-up ratio or a step-down ratio (hereinafter, referred to as step-up/down ratio) can be controlled by controlling an operation frequency of each of the switching devices or a pulse width of switching.

The battery 301 is a device accumulating power provided from the DC/DC converter 222 of the power reception circuit 212. A resistor (e.g., motor) that consumes the power may be used in place of the battery 301. The resistor and the battery are collectively referred to as a load device.

The control circuit 102 of the power transmission device 1 in FIG. 2 controls the AC power supply 121, the AC/DC converter 122, the DC/DC converter, and the inverter 124. As described above, the control circuit 102 includes the frequency control circuit 102A, the voltage control circuit 102B, and the switching signal generation circuit 102C.

The frequency control circuit 102A sweeps (modulates) the frequency (power transmission frequency) of the output AC power of the high-frequency power supply device 111 within the predetermined frequency range during the power transmission period. More specifically, the frequency control circuit 102A sweeps the frequency from a start frequency to an end frequency. Sweeping of the frequency is also referred to as modulation of the frequency. The frequency is changed by controlling the driving timing of the plurality of switching devices 501 to 504 as described above. For example, to increase the frequency, the frequency of each of the switching signals 501 to 504 is increased. In other words, the number of pulse ON/OFF repetition times per unit time is increased. To decrease the frequency, reversed operation is performed.

The start frequency and the end frequency are optionally defined. For example, the start frequency is the lowest frequency within the frequency range, and the end frequency is the highest frequency within the frequency range. Alternatively, the start frequency may be the highest frequency within the frequency range, and the end frequency may be the lowest frequency within the frequency range. A sweeping speed and a sweeping unit width (change width of frequency per one time) of the frequency can be previously determined.

FIG. 8 illustrates an example of the frequency sweeping. The frequency is swept from a start frequency f₁ to an end frequency f_{N}. Frequencies f₁, f₂, f₃, . . . , f_{N-2}, f_{N-1}, and f_{N} are disposed at fixed widths. The power transmission is started at the frequency f₁. After a predetermined time elapses, the frequency is moved to next frequency f₂, and the power transmission is performed at the frequency f₂. After the predetermined time elapses, the frequency is moved to next frequency f₃, and the power transmission is performed at the frequency f₃. The similar operation is repeatedly performed until the frequency f_{N}. When the power transmission at the frequency f_{N} is completed, the frequency is returned to the frequency f₁. The sweeping described here is illustrative, and the sweeping is not limited thereto. For example, the change width of the frequency per one time may be reduced, and the frequency may be smoothly moved from the frequency f₁ to the frequency f_{N}. Alternatively, the frequency may be moved in a discontinuous manner, for example, in order of f_{N-2}, f₃, f_{N-1}, f₂, . . . .

The voltage control circuit 102B of the control circuit 102 determines a target value of the interarm delay amount, based on the receiving voltage of the power reception circuit 212, namely, the receiving voltage of the power reception unit, and performs control to keep the interarm delay amount at the determined target value during the frequency sweeping. The receiving voltage of the power reception circuit 212 is also the input voltage of the rectifier 221. The interarm delay amount is controlled to the target value to suppress occurrence of a ripple voltage on the power reception side during the frequency sweeping.

The voltage control circuit 102B acquires information on one or both of the voltage and the current (hereinafter, voltage/current) at one or a plurality of predetermined positions in the high-frequency power supply device 111, and uses the acquired information to estimate the input voltage of the rectifier 221. The high-frequency power supply device 111 includes a detection circuit that detects the voltage/current at each of the predetermined positions. The voltage control circuit 102B determines the target value of the interarm delay amount based on the estimated input voltage. Note that, as described in a second embodiment described later, information on the input voltage may be received from the power reception side to specify the input voltage of the rectifier 221.

The relationship between the voltage/current at the one or each of the plurality of predetermined positions in the high-frequency power supply device 111 and the input voltage of the rectifier 221 is grasped from circuit simulation or a shipping test. Data representing the relationship (relationship data) is held as a table, a calculation formula, etc. Further, the input voltage of the rectifier 221 is estimated based on the relationship data and the above-described information on the voltage/current.

The voltage/current for estimation of the input voltage of the rectifier 221 can be detected at any position as long as the position has dependence relationship with the input voltage of the rectifier 221. Examples of the voltage to be detected include the output voltage of the AC/DC converter 122, the input voltage of the DC/DC converter 123, the input voltage of the inverter 124, the output voltage of the inverter 124, and the output voltage of the DC/DC converter 123. In addition, the voltage or the current at a terminal of an optional device inside the AC/DC converter 122, the DC/DC converter 123, or the inverter 124 may be detected.

In the related technology, the phase difference between the switching signals 501 and 503 is set to 180 degrees (see FIG. 5A) during the frequency sweeping (phase difference between switching signals 502 and 504 is also set to 180 degrees). In this case, however, there is an issue that ripple of the receiving voltage occurs on the power reception device 2 and the receiving current is varied.

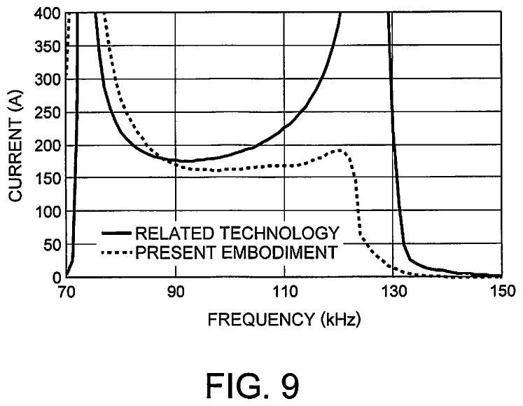

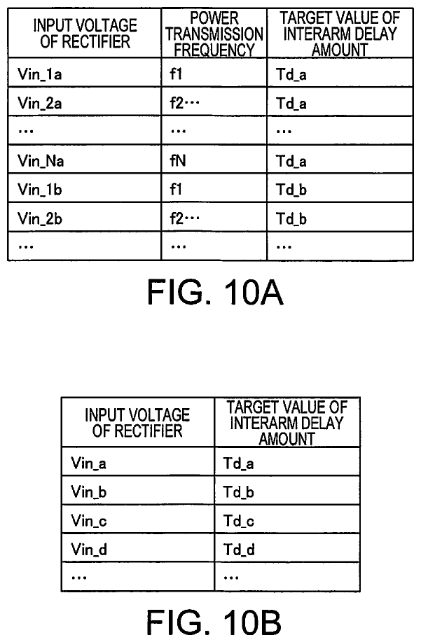

FIG. 9 illustrates, as a graph of the related technology, an example in which the receiving current (charging current) when the frequency is changed between 70 kHz and 150 kHz is calculated by simulation in the wireless power transmission system at the resonance frequency of 82 kHz. A SPICE (Simulation Program with Integrated Circuit Emphasis) is used for the simulation. A graph of the present embodiment described later is also illustrated in FIG. 9.

As a range actually used in the wireless power transmission in the frequency range of 70 kHz to 150 kHz, a range from 82 kHz (or slightly-small frequency) that is the resonance frequency to about 110 kHz is assumed. In this range, the receiving current is varied (increased) along with the increase of the frequency (i.e., ripple occurs). In the present embodiment, the control is performed so as to suppress variation of the receiving current. This is achieved by performing control so as to keep the interarm delay amount at the above-described target value during the frequency sweeping (i.e., by performing control so as to suppress variation of interarm delay amount during frequency sweeping). The graph of the present embodiment in FIG. 9 illustrates an example in which simulation was performed under a condition similar to the condition of the related technology. It is found that the variation of the receiving current can be suppressed within the frequency range of 90 kHz to 118 kHz. A method of determining the target value of the interarm delay amount is described in detail below.

A plurality of candidates of the interarm delay amount are generated. For example, the plurality of candidates of the interarm delay amount are generated at fixed intervals. Each of the candidates is sequentially selected. The power transmission device is started up, and the frequency is swept from the start frequency to the end frequency while performing control so as to keep the interarm delay amount at the selected candidate value. The frequency at the startup of the power transmission device may be the resonance frequency of the power transmission resonator or the power reception resonator, the start frequency of the sweeping range, or any other frequency. The receiving voltage (input voltage of rectifier), the receiving current, etc. of the power reception circuit 212 are measured during the frequency sweeping. The candidate at which variation of the receiving current is the lowest is specified within the range of the frequency sweeping or a part of the range. The specified candidate is regarded as the target value, and the target value is associated with a pair of the input voltage of the rectifier and the frequency at which the input voltage has been measured, and the target value and the pair are stored in a database (first database). The frequency may be the start frequency of the frequency sweeping, the end frequency, or any other frequency. Further, the frequency may be the resonance frequency or the frequency at the startup of the power transmission device. A plurality of pairs of the input voltage of the rectifier and the frequency may be generated, the target value may be associated with the plurality of pairs, and the target value and the pairs may be stored in the database. For example, the input voltage of the rectifier may be measured at each of the sweep frequencies from the start frequency to the end frequency, and each of the pairs of the frequency and the input voltage may be associated with the above-described specified candidate.

The receiving power on the power reception side is changed due to positional relationship between the coil on the power transmission side and the coil on the power reception side (e.g., intercoil distance) and other factors. Therefore, the relationship between the frequency and the receiving current as illustrated in FIG. 8 is also changed. Accordingly, the arrangement of the power reception device is changed, the target value is determined by performing processing similar to the above-described processing, the determined target value is associated with the pair of the input voltage of the rectifier and the frequency at which the input voltage has been measured, and the target value and the pair are stored in the above-described database. A plurality of pairs of the input voltage of the rectifier and the frequency may be generated, and the plurality of pairs may be associated with the determined target value. The arrangement of the power reception device is changed in a plurality of ways, and the similar processing is repeated. As a result, a plurality of target values are stored in the database, and each of the target values is associated with at least one pair of the input voltage and the frequency. In a case where the frequency used for estimation of the input voltage of the rectifier is previously determined, however, the target value may be associated with only the input voltage of the rectifier without being associated with the frequency, in the database.

FIG. 10A illustrates an example of the database. The target value of the interarm delay amount determined on each of arrangement a, b, c . . . of the power reception device is associated with the pair of each of the sweep frequencies from the start frequency to the end frequency within the sweep frequency range and the input voltage of the rectifier. For example, Td_a indicates a target value specified in a case of the arrangement a of the power reception device, and the target value is associated with a pair of an input voltage Vin_1a of the rectifier and a frequency f1, a pair of an input voltage Vin_2a of the rectifier and a frequency f2, etc. Vin_1a indicates the input voltage of the rectifier detected at the frequency f1. FIG. 10B illustrates another example of the database. In this example, only the input voltage of the rectifier and the interarm delay amount are stored. In the database of FIG. 10B, a case where the frequency used for estimation of the input voltage of the rectifier is previously determined is assumed.

The database is stored in, for example, a storage in the control circuit 102 or an external storage accessible from the control circuit 102. The storage may be a volatile memory such as a SRAM and a DRAM, or a nonvolatile memory such as a NAND, an MRAM, and an FRAM. Further, the storage may be a storage device such as a hard disk and an SSD. In this example, the database is constructed by the simulation. Alternatively, the database may be constructed by a test. In addition, in place of the database, a function to calculate the target value from at least the former of the input voltage of the rectifier and the frequency may be generated. In the following description, the example using the database is described; however, the function may be used.

The voltage control circuit 102B specifies, from the above-described database (see FIG. 10A), the target value corresponding to the pair of the above-described estimated input voltage of the rectifier 221 and the power transmission frequency at which the input voltage has been estimated. In the case where the frequency used for estimation of the input voltage of the rectifier is previously determined, the target value corresponding to the input voltage of the rectifier is specified from the database (see FIG. 10B).

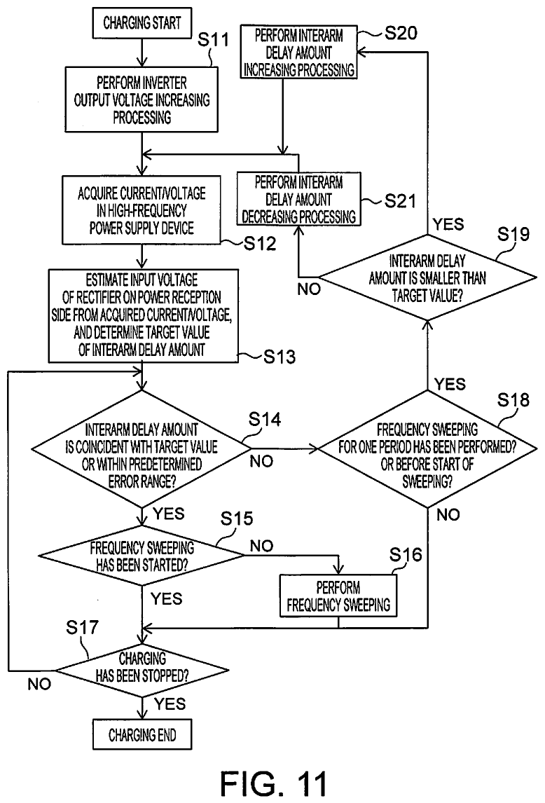

FIG. 11 is a flowchart of operation by the control circuit 102 according to the first embodiment.

In step S11, when receiving a charge control instruction from an external device, the voltage control circuit 102B of the control circuit 102 performs startup operation, and raises the output voltage of the inverter 124 to the target voltage. Examples of the external device include an input interface (e.g., touch panel) for the user, a controller of the wireless power transmission system, and any other devices. The power transmission frequency at the startup operation is, for example, the resonance frequency of the power transmission resonator or the power reception resonator, a frequency close to the resonance frequency, or any other frequency within the sweeping range.

In step S12, when the output voltage of the inverter 124 reaches the target voltage, power transmission is started at the startup frequency (frequency sweeping is not started at this time), and the voltage control circuit 102B acquires the information on the voltage/current at the one or the plurality of predetermined positions in the high-frequency power supply device 111.

In step S13, the voltage control circuit 102B estimates the input voltage of the rectifier 221 (receiving voltage of power reception circuit 212) from the acquired information on the voltage/current with use of the above-described relationship data. The target value of the interarm delay amount is determined from the above-described database (first database), based on at least the former of the estimated input voltage and the power transmission frequency at which the input voltage has been estimated.

In step S14, the voltage control circuit 102B determines whether the interarm delay amount satisfies a target condition. The interarm delay amount can be specified through, for example, measurement of a signal level of each of the switching signals. In a case where the interarm delay amount is coincident with the target value or is within a predetermined error range of the target value, it is determined that the interarm delay amount satisfies the target condition, and otherwise, it is determined that the interarm delay amount does not satisfy the target condition. The predetermined error range is previously determined in such a manner that the variation of the receiving current is within an allowable range, for example, a range plus/minus a from the target value. The value a may be a predetermined value, or a value obtained by multiplying the target value by a constant coefficient. The predetermined error range may be determined from the result of the above-described simulation.

In a case where the interarm delay amount satisfies the target condition (YES in step S14), it is determined in step S15 whether the frequency sweeping has been started. In step S15 at first time after the processing of the flowchart is started, the frequency sweeping has not been started yet (NO in step S15). Accordingly, the processing proceeds to step S16, and the frequency control circuit 102A starts the frequency sweeping. Thereafter, the processing proceeds to step S17.

In step S17, it is determined whether an end condition of the charging has been satisfied. Examples of the end condition include a case where a predetermined time elapses after the power transmission is started, a case where charging of the battery 301 is completed, and a case where a charging end instruction is received from the user of the battery through the input interface. In a case where the end condition has been satisfied (YES), the processing ends. In a case where the end condition has not been satisfied (NO), the processing returns to step S14.

In a case where it is determined in step S14 that the interarm delay amount does not satisfy the target condition (NO), it is determined in step S18 whether the sweeping for one period has been completed or before start of the sweeping (i.e., whether processing in step S16 has been executed).

Completion of the sweeping for one period indicates completion of the sweeping from the start frequency to the end frequency within the sweeping range. In a case where it is determined that the sweeping for one period has been completed or before start of the sweeping, the processing proceeds to step S19 in order to adjust the interarm delay amount. In contrast, in a case other than the above, namely, in a case where the sweeping for one period has not been completed (i.e., in middle of sweeping) (NO), the processing proceeds to step S17. In other words, after the sweeping is started, the interarm delay amount is not adjusted until the sweeping of the period is completed.

In step S19, it is determined whether the interarm delay amount is smaller than the target value. In a case where the interarm delay amount is smaller than the target value (YES in step S19), the switching signal generation circuit 102C is controlled so as to increase the interarm delay amount (step S20). For example, control is performed so as to increase the interarm delay amount by a difference between the current interarm delay amount and the target value. This makes it possible to bring the interarm delay amount close to the target value or to settle the interarm delay amount within the predetermined error range. As another method, the interarm delay amount may be increased by a predetermined increase degree Δα₁.

In contrast, in a case where the interarm delay amount is larger than the target value (NO in step S19), the switching signal generation circuit 102C is controlled so as to decrease the interarm delay amount in step S21. For example, the interarm delay amount is decreased by the difference between the current interarm delay amount and the target value. This brings the interarm delay amount close to the target value or settles the interarm delay amount within the predetermined error range. As another method, the interarm delay amount may be decreased by a predetermined decrease degree Δγ₁.

After the interarm delay amount is increased or decreased in step S20 or S21, the processing returns to step S12. In step S12 and in subsequent step S13, for example, the input voltage of the rectifier at the start frequency is estimated, and the target value of the interarm delay amount is determined (target value may be same as or different from previous target value). Thereafter, processing in step S14 is similar to the processing described above.

In the operation of this flowchart, the interarm delay amount is adjusted after the frequency is swept from the start frequency to the end frequency; however, the interarm delay amount may be adjusted in the middle of the sweeping. For example, in a case where it is determined in step S14 that the interarm delay amount does not satisfy the target condition, the interarm delay amount may be adjusted at that time (without waiting completion of current sweeping period).

In the operation of this flowchart, the target value is determined again in steps S12 and S13 after step S20 or S21. In a case where possibility of variation of the target value is low because the position of the power reception device is kept after the charging is started, steps S12 and S13 may be skipped and the processing may proceed to step S14.

As described above, the frequency sweeping is performed while generation of the switching signals is controlled such that the interarm delay amount satisfies the target condition, which makes it possible to suppress variation of the receiving current (occurrence of ripple) on the power reception side while reducing radiation magnetic field intensity. As a result, it is possible to prevent a large load from being applied to the electric circuit on the power reception side, and to suppress reduction of the battery lifetime.

In addition, the power transmission side estimates the input voltage of the rectifier from the voltage/current at the predetermined positions in the high-frequency power supply device. In other words, the relationship between the voltage/current at the predetermined positions and the input voltage of the rectifier is previously acquired, and the voltage on the power reception side is estimated with use of the relationship data. Accordingly, it is unnecessary to feed back the state of the power reception device 2 to the power transmission device 1. This simplifies the configuration.

In the present embodiment, the target value of the interarm delay amount is determined from the input voltage of the rectifier. Alternatively, the target value of the interarm delay amount may be determined from the voltage/current at the other position of the power reception circuit. Also in this case, the voltage/current at the other position of the power reception circuit can be estimated from the voltage/current at the predetermined position in the high-frequency power supply device, and the target value of the interarm delay amount can be determined from the estimated voltage/current.

### Second Embodiment

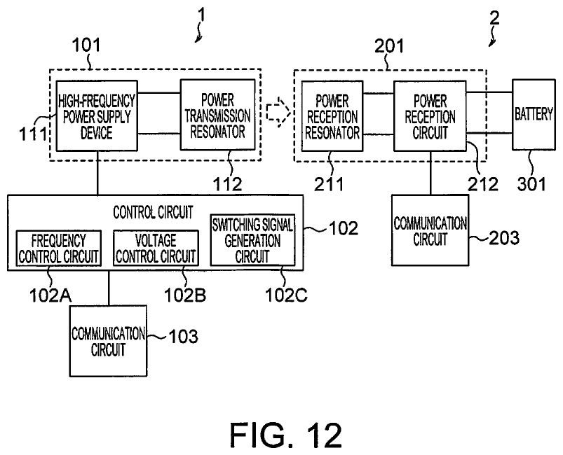

FIG. 12 illustrates a wireless power transmission system according to a second embodiment. The components same as or corresponding to the components in FIG. 1 are denoted by the same reference numerals, and description of such components is appropriately omitted. A communication circuit 103 is added to the power transmission side, and a communication circuit 203 is added to the power reception side in the system illustrated in FIG. 1. The communication circuit 103 on the power transmission side is connected to the control circuit 102. The communication circuit 203 on the power reception side is connected to the power reception circuit 212. The communication circuits 103 and 203 communicate with each other based on a predetermined procedure. The communication may be wireless communication or wired communication. In a case of the wireless communication, one or more antennae are mounted on each of the communication circuits 103 and 203.

In the first embodiment, the voltage control circuit 102B on the power transmission side estimates the input voltage of the rectifier 221 on the power reception side (receiving voltage of power reception circuit 212) from the voltage/current at the predetermined position in the high-frequency power supply device 111. In the present embodiment, instead of the estimation of the input voltage of the rectifier 221, the communication circuit 203 on the power reception side transmits information representing the input voltage of the rectifier 221. The communication circuit 103 receives the information from the communication circuit 203, and transfers the received information to the voltage control circuit 102B.

The power reception circuit 212 or the rectifier 221 includes a detection circuit that detects the input voltage of the rectifier (receiving voltage of power reception circuit). The detection circuit notifies the information representing the detected input voltage to the communication circuit 203. The communication circuit 203 transmits the information to the power transmission device 1. The detection circuit may detect the input voltage of the rectifier at a predetermined interval, or may detect the input voltage of the rectifier at timing when a measurement instruction is received from the power transmission device 1. In the latter case, the control circuit 102 transmits the instruction to measure the input voltage of the rectifier, through the communication circuit 103. The communication circuit 203 receives the measurement instruction, and notifies the received measurement instruction to the power reception circuit 212 or the rectifier 221.

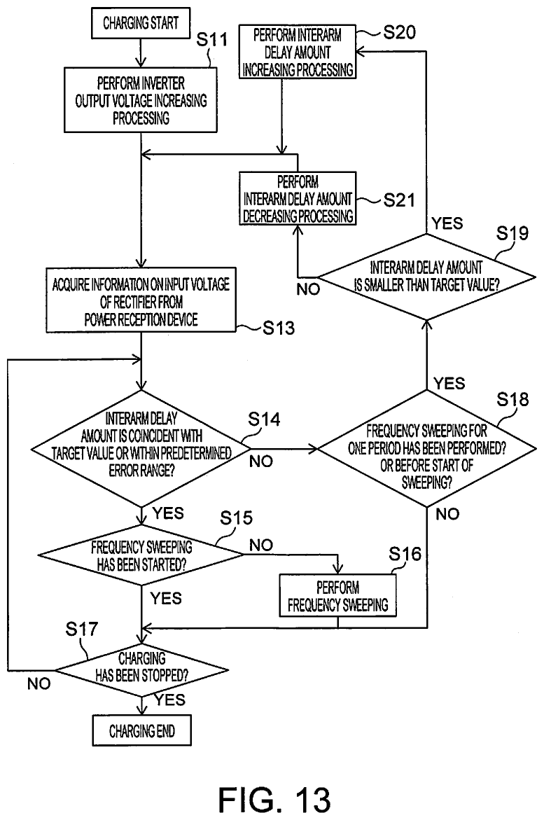

FIG. 13 is a flowchart of operation by the control circuit 102 according to the present embodiment. Step S12 in FIG. 11 is removed, and step S13 is changed to step S23. In step S23, the information representing the input voltage of the rectifier 221 (receiving voltage of power reception circuit 212) is acquired from the power reception device 2 through communication. Other operation is similar to the operation in the first embodiment.

According to the present embodiment, since it is sufficient for the control circuit 102 of the power transmission device 1 to acquire the information representing the input voltage of the rectifier 221 from the power reception device 2 (it is unnecessary to estimate input voltage of rectifier), it is possible to simplify the configuration of the power transmission device.

### Third Embodiment

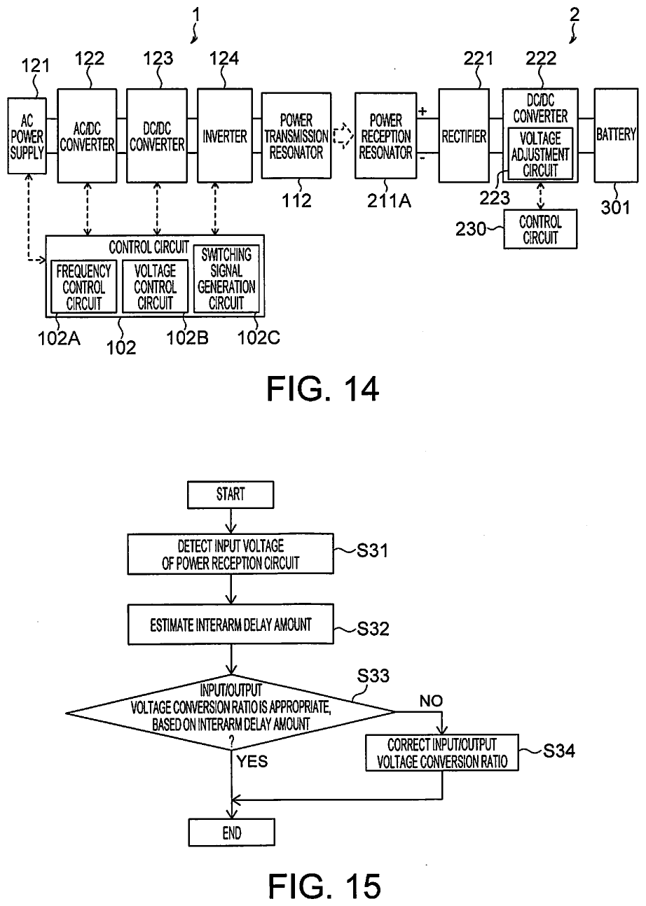

FIG. 14 illustrates a wireless power transmission system according to a third embodiment. The components same as or corresponding to the components in FIG. 1, FIG. 4, and FIG. 7 are denoted by the same reference numerals, and description of such components is appropriately omitted.

A control circuit 230 is provided in the power reception device 2. In addition, a voltage adjustment circuit 223 is provided in the DC/DC converter 222. The control circuit 230 is connected to the DC/DC converter 222. The control circuit 230 estimates the interarm delay amount of the inverter 124 on the power transmission side, based on the voltage/current at one or a plurality of positions in the power reception circuit (rectifier 221 and DC/DC converter 222). The power reception circuit includes a detection circuit that detects the voltage/current at the one or each of the plurality of positions. The control circuit 230 determines an input/output voltage conversion ratio of the DC/DC converter 222 based on the estimated interarm delay amount. The control circuit 230 outputs an instruction signal to specify the determined conversion ratio, to the voltage adjustment circuit 223 of the DC/DC converter. The voltage adjustment circuit 223 adjusts the input/output voltage conversion ratio based on the instruction signal. The input/output voltage conversion ratio is adjusted, for example, for each period of the frequency sweeping. In this case, the input/output voltage conversion ratio is kept during one period of the frequency sweeping.

FIG. 15 is a flowchart of an example of operation by the control circuit 230 in the power reception device 2 according to the present embodiment. The operation of this flowchart is started, as an example, for each period of the frequency sweeping, for example, at the time when the frequency in the sweeping is returned to the start frequency. The control circuit 230 previously knows the start timing of the period of the frequency sweeping, or acquires information representing the start timing of the period of the frequency sweeping from the power transmission device 1 through communication. For example, the power transmission device 1 may transmit a trigger signal to the power reception device 2 for each period of the frequency sweeping, and the power reception device 2 may determine the start timing of the period based on the trigger signal. The start timing of the period of the frequency sweeping may be determined by other methods.

When the operation of this flowchart is started, the control circuit 230 specifies the voltage/current at the one or each of the plurality of positions in the power reception circuit in step S31. In this case, for example, the input voltage of the rectifier 221 is specified. Subsequently, the control circuit 230 estimates the interarm delay amount of the inverter 124 on the power transmission side based on the specified input voltage (step S32). It is determined whether the input/output voltage conversion ratio of the DC/DC converter 222 is appropriate, based on the estimated interarm delay amount (step S33). In a case where it is determined that the input/output voltage conversion ratio is appropriate (YES), the processing ends. In a case where it is determined that the input/output voltage conversion ratio is not appropriate (NO), the appropriate input/output voltage conversion ratio is determined, and a signal representing the determined value is output to the voltage adjustment circuit 223 (step S34). The voltage adjustment circuit 223 corrects the input/output voltage conversion ratio to the value represented by the signal.

The processing in step S32 is described in detail. A database (second database) in which the input voltage of the rectifier 221 is associated with the interarm delay amount, and a database (third database) in which the interarm delay amount is associated with the input/output voltage conversion ratio are stored in the storage of the control circuit 230 or in an external storage accessible from the control circuit 230. The storage may be a volatile memory such as an SRAM and a DRAM, or a nonvolatile memory such as a NAND, an MRAM, and an FRAM. In addition, the storage may be a storage device such as a hard disk and an SSD. The second database can be constructed by acquiring the relationship between the input voltage of the rectifier 221 and the interarm delay amount from a simulation or a test. The third database can be basically constructed such that the variation of the receiving current is suppressed, based on the database construction method according to the first embodiment. The frequency at which the input voltage of the rectifier has been detected may be included in the database, as with the first embodiment. The control circuit 230 specifies, in the second database, the interarm delay amount corresponding to the input voltage specified in step S31, and the specified interarm delay amount is regarded as the estimated interarm delay amount of the inverter 124.

In step S33, the input/output voltage conversion ratio corresponding to the interarm delay amount estimated in step S32 is specified in the third database. In a case where the current input/output voltage conversion ratio of the DC/DC converter 122 is coincident with the specified input/output voltage conversion ratio or within the predetermined error range (YES in step S33), it is determined that the current input/output voltage conversion ratio is appropriate. In a case other than the above (NO in step S33), it is determined that the current input/output voltage conversion ratio is not appropriate. The instruction signal is transmitted to the voltage conversion circuit such that the input/output voltage conversion ratio of the DC/DC converter 122 becomes the specified input/output voltage conversion ratio (step S34).

According to the present embodiment, it is possible to further suppress variation of the receiving current by also adjusting the input/output voltage conversion ratio of the DC/DC converter 122.

### Fourth Embodiment

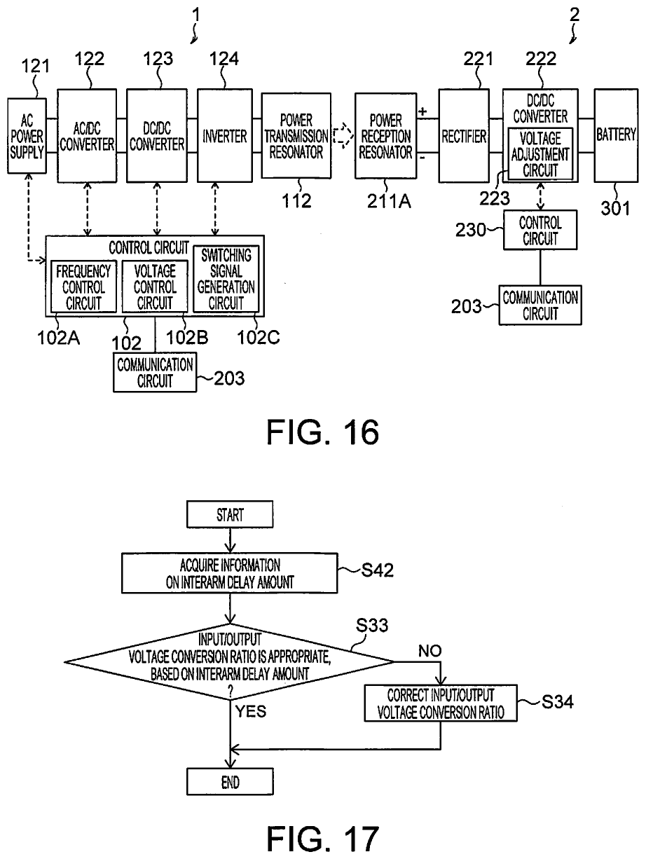

FIG. 16 illustrates a wireless power transmission system according to a fourth embodiment. The communication circuit 103 is added to the power transmission side, and the communication circuit 203 is added to the power reception side in the system illustrated in FIG. 14. The components same as or corresponding to the components in FIG. 1, FIG. 4, FIG. 7, and FIG. 14 are denoted by the same reference numerals, and description of such components is appropriately omitted.

In the third embodiment, the interarm delay amount is estimated on the power reception side. In the fourth embodiment, information on the interarm delay amount (or target value of interarm delay amount, same hereinafter) is transmitted from the communication circuit 103 of the power transmission device 1 to the communication circuit 203 of the power reception device 2. The communication circuit 203 receives the information on the interarm delay amount from the communication circuit 103. The power transmission device 1 transmits the information on the interarm delay amount, for example, for each period of the frequency sweeping such as at the time when the interarm delay amount is corrected (see steps S20 and S21 in FIG. 11) and at the time when the frequency sweeping is started (see step S16 in FIG. 11). The control circuit 230 of the power reception device 2 uses the interarm delay amount represented by the received information to adjust the input/output voltage conversion ratio of the DC/DC converter 222.

FIG. 17 is a flowchart of operation by the control circuit 230 according to the present embodiment. Step S31 in FIG. 15 is removed, and step S32 is changed to step S42. In step S42, the information on the interarm delay amount of the inverter 124 is acquired from the power transmission device 1. In subsequent step S33, it is determined whether the input/output voltage conversion ratio of the DC/DC converter 122 is appropriate, based on the acquired information. The processing other than the above is similar to the processing in the first embodiment.

According to the present embodiment, since it is sufficient for the control circuit 230 of the power reception device 2 to acquire the information representing the interarm delay amount of the inverter 124 on the power transmission side from the power transmission device 1 (it is unnecessary to estimate interarm delay amount of inverter 124 on power transmission side), it is possible to simplify the configuration of the power reception device 2.

### Fifth Embodiment

As with the third or fourth embodiment, the value of the input/output voltage conversion ratio of the DC/DC converter 123 can be kept during the frequency sweeping also in the above-described first and second embodiments. In a manner similar to the third or fourth embodiment, the input/output voltage conversion ratio can be determined from the measured interarm delay amount (or target value of interarm delay amount), and the value of the input/output voltage conversion ratio can be kept at the determined value. Specific description is omitted because it is obvious from the description in the third and fourth embodiments. It is possible to further suppress the variation of the receiving current by also adjusting the input/output voltage conversion ratio of the DC/DC converter 123.

### Sixth Embodiment

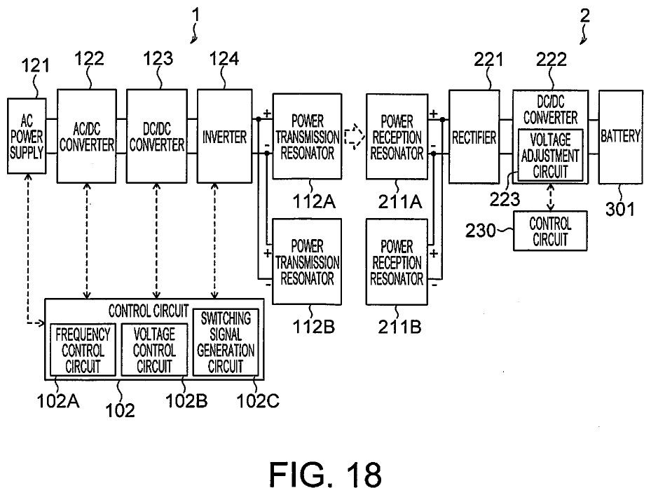

FIG. 18 illustrates a wireless power transmission system according to a sixth embodiment. The components same as or corresponding to the components in FIG. 1, FIG. 2, and FIG. 7 are denoted by the same reference numerals, and description of such components is appropriately omitted.

In the first embodiment, one power transmission resonator and one power reception resonator are provided. In the present embodiment, two power transmission resonators and two power reception resonators are provided. In other words, the wireless power transmission is performed by two systems.

Each of a power transmission resonator 112A and a power transmission resonator 112B is connected to the output terminals (plus terminal and minus terminal) of the inverter 124. Polarities of the connection, however, are inverted from each other. In other words, a plus terminal of the power transmission resonator 112A is connected to the plus terminal of the inverter 124, and a minus terminal of the power transmission resonator 112A is connected to the minus terminal of the inverter 124. In contrast, a plus terminal of the power transmission resonator 112B is connected to the minus terminal of the inverter 124, and a minus terminal of the power transmission resonator 112B is connected to the plus terminal of the inverter 124. As a result, the current output from the inverter 124 is provided to the power transmission resonator 112A and the power transmission resonator 112B, as currents (anti-phase currents) shifted in phase by 180 degrees or substantially 180 degrees from each other. The phases are reversed in the above-described manner, which cancels the magnetic field radiated from the power transmission resonator 112A and the magnetic field radiated from the power transmission resonator 112B from each other in a distant location, to reduce leakage magnetic field. Note that the phase difference to obtain the magnetic field cancelling effect is not necessarily 180 degrees, and for example, a phase difference within a range plus/minus a from 180 degrees may be provided to obtain reduction effect of a desired degree.

The magnetic field generated from the power transmission resonator 112A and the magnetic field generated from the power transmission resonator 112B are respectively coupled by power reception resonators 211A and 211B. The power reception resonator 211A and the power reception resonator 2118 are connected to the input terminals (plus terminal and minus terminal) of the rectifier 221. Polarities of the connection, however, are inverted from each other. In other words, a plus terminal of the power reception resonator 211A is connected to the plus terminal of the rectifier 221, and a minus terminal of the power reception resonator 211A is connected to the minus terminal of the rectifier 221. In contrast, a plus terminal of the power reception resonator 211B is connected to the minus terminal of the rectifier 221, and a minus terminal of the power reception resonator 211B is connected to the plus terminal of the rectifier 221. As a result, the power reception resonator 211A and the power reception resonator 211B output in-phase currents, and total power corresponding to the sum of these currents is supplied to the rectifier 221.

In the present embodiment, the wireless power transmission is performed by two systems; however, the wireless power transmission may be performed by three or more systems. In this case, when the number of systems is denoted by N, it is sufficient to control the phase of the output current of the inverter 124 such that currents shifted in phase by 360 degrees/N or by substantially 360 degrees/N are provided to N power transmission resonators.

In the present embodiment, the output of the inverter 124 is shared by the power transmission resonators 112A and 112B; however, the inverter may be individually connected to each of the power transmission resonators. This makes it possible to control inverter driving for each power transmission resonator.

The configuration other than the above is the same as the configuration according to the first embodiment. The configuration including two or more systems in the present embodiment is similarly applicable to the configuration according to any of the second to fifth embodiments.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A power transmission device, comprising:
an inverter including a first arm and a second arm that are connected in parallel, the first arm including series connection of first and second switching devices, and the second arm including series connection of third and fourth switching devices;
a first control circuit configured to control first to fourth switching signals to be supplied to the first to fourth switching devices, to generate AC power from the inverter; and
a power transmission resonator configured to couple a magnetic field corresponding to the AC power to a coil of a power reception unit to transmit the AC power,
the power transmission resonator including a first end and a second end,
the first end being electrically connected to a connection point between the first and second switching devices, and
the second end being electrically connected to a connection point between the third and fourth switching devices, wherein
the first control circuit sweeps a frequency of the AC power during the transmission of the AC power, and
the first control circuit controls to suppress variation of a time delay amount between the first and second arms during sweeping of the frequency.

2. The power transmission device according to claim 1, wherein
the first control circuit estimates a received voltage of the power reception unit based on at least one of a voltage and a current at a predetermined position in a power transmission unit that includes the inverter and the power transmission resonator,
the first control circuit determines a target value of the time delay amount based on the estimated receiving voltage, and
the first control circuit performs control to keep the time delay amount at the target value.

3. The power transmission device according to claim 1, wherein
the first control circuit receives information representing a received voltage of the power reception unit through communication,
the first control circuit determines a target value of the time delay amount based on the information, and
the first control circuit controls to keep the time delay amount at the target value.

4. The power transmission device according to claim 1, further comprising a first DC/DC converter configured to convert DC power and to supply the converted DC power to the inverter, wherein
the first control circuit controls an input/output voltage conversion ratio of the first DC/DC converter based on the time delay amount between the first and second arms.

5. The power transmission device according to claim 1, further comprising a plurality of the power transmission resonators each configured to transmit the AC power.

6. A power reception device, comprising:
a power reception unit configured to receive the AC power from a power transmission device; and
a second control circuit, wherein
the power transmission device includes;
an inverter including a first arm and a second arm that are connected in parallel, the first arm including series connection of first and second switching devices, and the second arm including series connection of third and fourth switching devices,
a first control circuit configured to control first to fourth switching signals to be supplied to the first to fourth switching devices, to generate AC power from the inverter, and
a power transmission resonator configured to couple a magnetic field corresponding to the AC power to a coil of a power reception unit to transmit the AC power, the power transmission resonator including a first end and a second end, the first end being electrically connected to a connection point between the first and second switching devices, and the second end being electrically connected to a connection point between the third and fourth switching devices, wherein
the first control circuit sweeps a frequency of the AC power during the transmission of the AC power, and
the first control circuit controls to suppress variation of a time delay amount between the first and second arms during sweeping of the frequency.
the power reception unit includes; a power reception resonator receiving the AC power transmitted from the power transmission resonator, a rectifier rectifying the received AC power, and a second DC/DC converter converting the rectified DC power, and
the second control circuit keeps an input/output voltage conversion ratio of the second DC/DC converter at a value depending on the time delay amount between the first and second arms during the sweeping of the frequency.

7. The power reception device according to claim 6, wherein
the second control circuit estimates the time delay amount between the first and second arms based on at least one of a voltage and a current at a predetermined position in the power reception unit,
the second control circuit determines the input/output voltage conversion ratio of the second DC/DC converter based on the estimated time delay amount, and
the second control circuit keeps the input/output voltage conversion ratio of the second DC/DC converter at the determined input/output voltage conversion ratio during the sweeping of the frequency.

8. The power reception device according to claim 6, wherein
the second control circuit receives information on the time delay amount between the first and second arms through communication with the power transmission device,
the second control circuit determines the input/output voltage conversion ratio of the second DC/DC converter based on the information, and
the second control circuit keeps the input/output voltage conversion ratio of the second DC/DC converter at the determined input/output voltage conversion ratio during the sweeping of the frequency.

9. The power reception device according to claim 6, wherein
the power transmission device includes a plurality of the power transmission resonators each configured to transmit the AC power, and
the power reception unit includes a plurality of power reception resonators configured to receive the AC power from the power transmission resonators.
